(19) United States
(12) Patent Application Publication
(10) Pub. No.: US 2014/0178185 A1
(43) Pub. Date: Jun. 26, 2014

(54) EGRESS SEAL ASSEMBLY

(71) Applicant: UNITED TECHNOLOGIES CORPORATION, Hartford, CT (US)

(72) Inventors: Eli C. Warren, Wethersfield, CT (US); Marcus D. Baltrucki, Marlborough, CT (US)

(73) Assignee: UNITED TECHNOLOGIES CORPORATION, Hartford, CT (US)

(21) Appl. No.: 13/725,249

(22) Filed: Dec. 21, 2012

(51) Int. Cl. H02G 15/013

(52) U.S. Cl. CPC H02G 15/013
USPC 415/182.1; 174/652

(57) ABSTRACT

A seal assembly includes a first ferrule that surrounds the lead and a second ferrule that surrounds the lead.

### BACKGROUND

The present disclosure relates to a seal assembly and, more particularly, to a hard mechanical seal for a tubular lead.

Gas turbine engines are typically instrumented when under development. An instrumentation probe to measure, for example temperature or pressure, is connected through a hard lead with a close mechanical fit to an engine case structure. When such an instrumentation probe is utilized in conjunction with a hostile environment such as, for example, a compressor or turbine section of the gas turbine engine, the close mechanical fit is provided by a potting material. Although effective, the potting material may tend to release over time.

### SUMMARY

A seal assembly according to one disclosed non-limiting embodiment of the present disclosure includes a lead, a first ferrule that surrounds said lead, and a second ferrule that surrounds said lead.

In a further embodiment of the foregoing embodiment, the first ferrule is opposed to said second ferrule.

In a further embodiment of any of the foregoing embodiments, the first ferrule and said second ferrule include opposed convex surfaces.

In a further embodiment of any of the foregoing embodiments, the first ferrule and said second ferrule include opposed ramped surfaces.

In a further embodiment of any of the foregoing embodiments, the first ferrule is brazed to said lead.

In a further embodiment of any of the foregoing embodiments, the second ferrule includes a nut and an adapter with a threaded interface therebetween. In the alternative or additionally thereto, in the foregoing embodiment the adapter is brazed to the lead. In the alternative or additionally thereto, in the foregoing embodiment the nut includes a convex surface. In the alternative or additionally thereto, in the foregoing embodiment the nut is opposed to said first ferrule.

An assembly according to another disclosed non-limiting embodiment of the present disclosure includes a structure that includes an aperture along an axis, said aperture includes an inner counterbore and an outer counterbore separated by an intermediate section, a lead that extends through said aperture along said axis, an inner ferrule that surrounds said lead and interfaces with said inner counterbore, and an outer ferrule that surrounds said lead and interfaces with said outer counterbore.

In a further embodiment of the foregoing embodiment, the assembly includes a potting material within said intermediate section.

In a further embodiment of any of the foregoing embodiments, the inner ferrule and said outer ferrule includes a convex surface that abuts an inner intermediate interface surface between said inner counterbore and said intermediate section and an outer intermediate interface surface between said outer counterbore and said intermediate section.

In a further embodiment of any of the foregoing embodiments, the inner ferrule is brazed to said lead.

In a further embodiment of any of the foregoing embodiments, the second ferrule includes a nut and an adapter with a threaded interface therebetween. In the alternative or additionally thereto, in the foregoing embodiment the adapter is brazed to the lead

A gas turbine engine according to another disclosed non-limiting embodiment of the present disclosure includes a case that includes an aperture along an axis, said aperture includes two (2) opposed counterbore separated by an intermediate section.

In a further embodiment of the foregoing embodiment, each counterbore defines a first diameter and said intermediate section defines a second diameter, said first diameter greater than said second diameter.

In a further embodiment of any of the foregoing embodiments, the gas turbine engine includes an interface that spans each counterbore and said intermediate section.

In a further embodiment of any of the foregoing embodiments, the axis is angled with respect to an outer surface of said case.

In a further embodiment of any of the foregoing embodiments, the gas turbine engine includes a lead that extends through said aperture along said axis, an inner ferrule that surrounds said lead and interfaces with said inner counterbore, and an outer ferrule that surrounds said lead and interfaces with said outer counterbore.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic view of an example gas turbine engine;

FIG. 2 is an expanded cross-sectional view of a seal assembly according to one disclosed non-limiting embodiment;

FIG. 3 is an expanded cross-sectional view an aperture to receive a seal assembly;

FIG. 4 is an expanded cross-sectional view of the seal assembly of FIG. 2 during assembly;

FIG. 5 is an expanded cross-sectional view of the seal assembly of FIG. 2 during assembly;

FIG. 6 is an expanded cross-sectional view of the seal assembly of FIG. 2 during assembly;

FIG. 7 is an expanded cross-sectional view of a seal assembly according to another disclosed non-limiting embodiment;

FIG. 8 is an expanded cross-sectional view of a seal assembly according to another disclosed non-limiting embodiment;

FIG. 9 is an expanded and isometric view of the seal assembly of FIG. 8;

### DETAILED DESCRIPTION

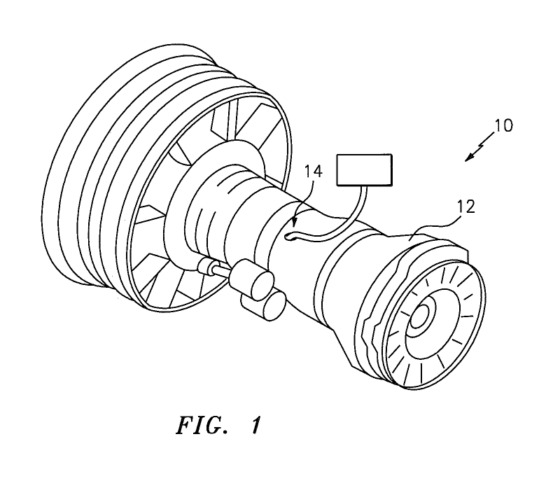

FIG. 1 schematically illustrates a gas turbine engine 10 with a case structure 12. Although depicted as a turbofan gas turbine engine in the disclosed non-limiting embodiment, it should be appreciated that the concepts described herein are not limited to use with high-bypass turbofans as the teachings may be applied to other types of turbine engines such as an augmented turbofan, turboshaft, geared architecture, turbojet and industrial gas turbine engine.

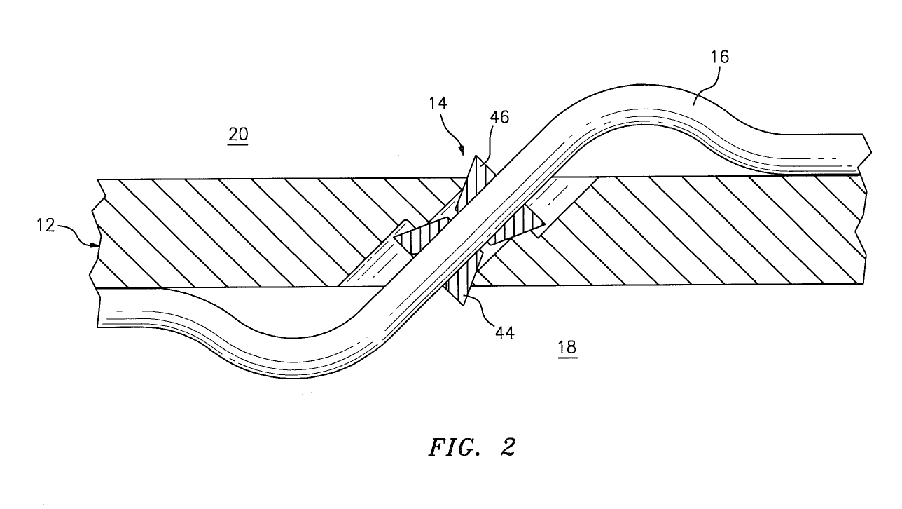

With reference to FIG. 2, a seal assembly 14 seals a lead 16 that passes between an interior 18 and an exterior 20. That is, the seal assembly 14 provides a seal for the lead 16 though the case structure 12. In the disclosed non-limiting embodiment, the lead 16 is a hollow metal conduit through which wires, airflow or other communicant may be sealed and protected, the lead 16 may be a flexible metal braided hose or solid metal tube which is relatively flexible. Furthermore, although depicted as a lead that passes through the case of a gas turbine engine in the disclosed non-limiting embodiment, it should be understood that the concepts described herein are not limited to use only therewith. For example, the teachings disclosed herein may be applied to other structural interfaces such as, for example, conduits that pass airflow therethrough.

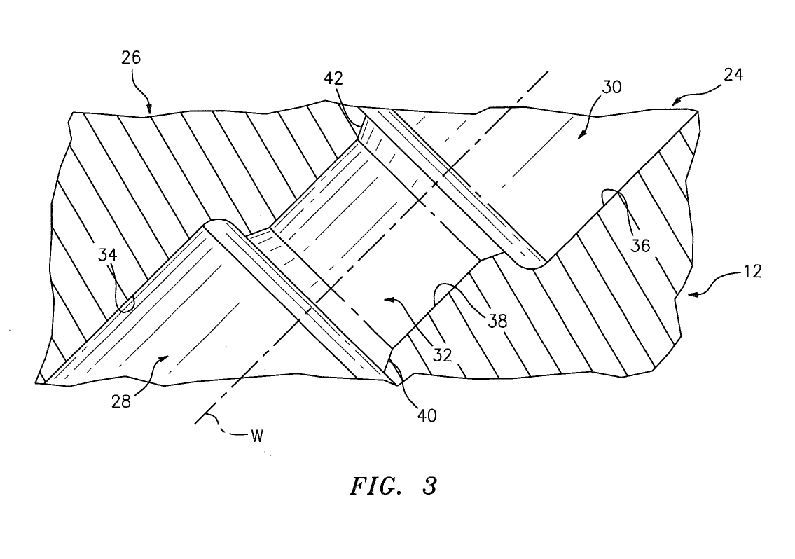

With reference to FIG. 3, the case structure 12 defines an aperture 24 along an axis W which may be angled with respect an outer surface 26 of the case structure 12. The aperture 24 generally includes two (2) opposed counterbore 28, 30 separated by an intermediate section 32. Each counterbore 28, 30 defines a diameter 34, 36 that is greater than a diameter 38 defined by the intermediate section 32. An intermediate interface surface 40, 42 blends each counterbore 28, 30 with the intermediate section 32 to receive a respective inner and outer ferrule 44, 46 (FIG. 2). The intermediate interface surfaces 40, 42 may be, for example, ramped, concave or otherwise matched to an outer surface of the respective ferrule 44, 46.

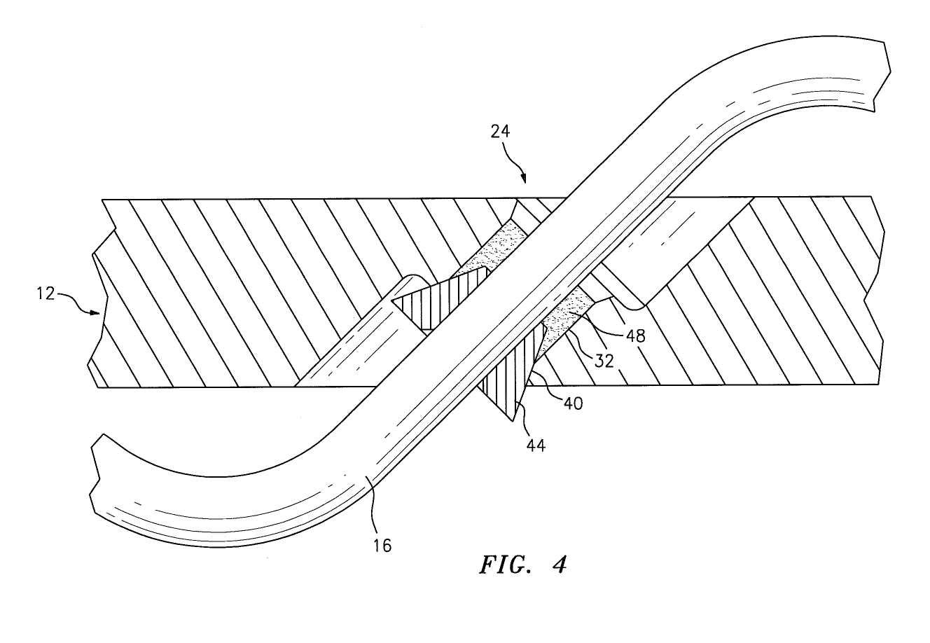

With reference to FIG. 4, assembly of the lead 16 into the structure 12 is initiated with the inner ferrule 44 brazed or otherwise attached to the lead 16. The lead 16 is then routed through the aperture 24 and pulled tight so the ferrule 44 seats on the intermediate interface surface 40 and extends at least partially into the intermediate section 32.

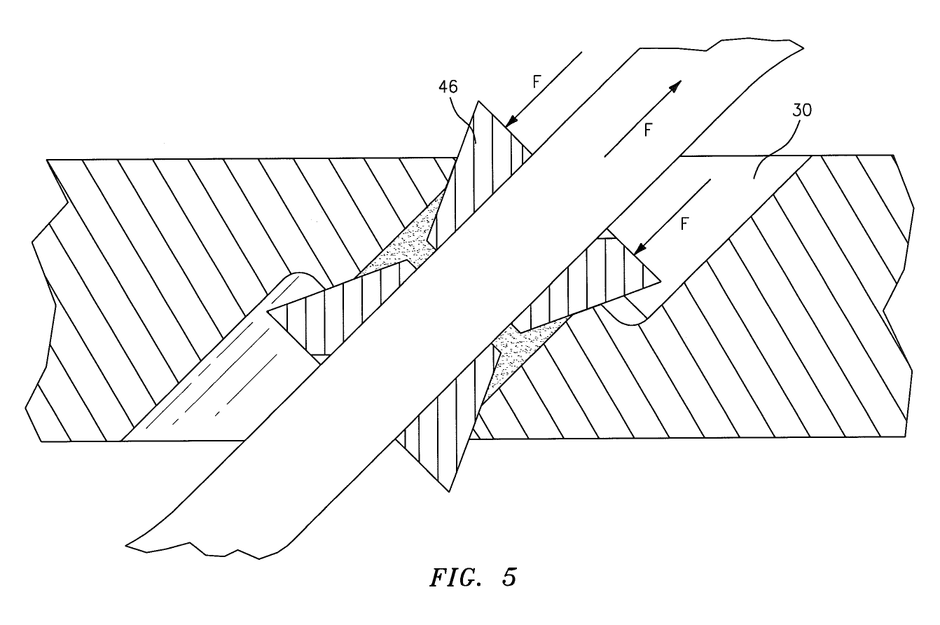

The intermediate section 32 is then at least partially filled with high-temp, e.g., greater than 2000 F (1093 C) potting material 48 and allowed to cure. Then, while the lead 16 is held in tension, the outer ferrule 46 is pushed into the counterbore 30 opposed to said inner ferrule 44 until seated on the intermediate interface surface 42. The outer ferrule 46 is then brazed or otherwise attached to the lead (FIG. 5).

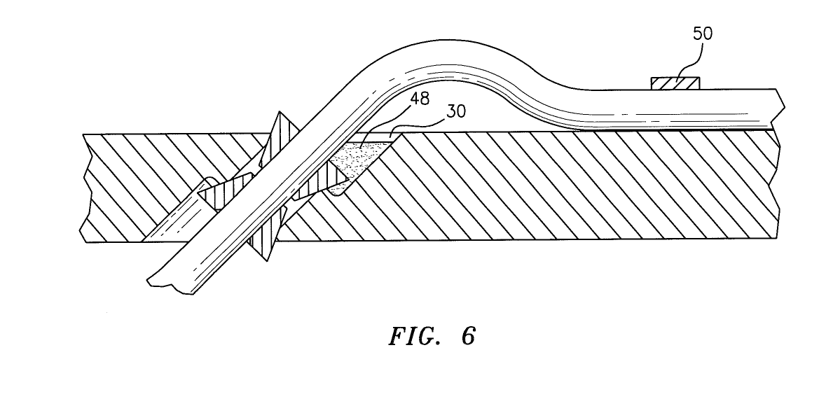

With reference to FIG. 6, the counterbore 30 is then filled with potting material 48. The lead 16 may additionally be restrained with respect to the outer surface 26 of the case structure 12 with a strap 50 or other retainer.

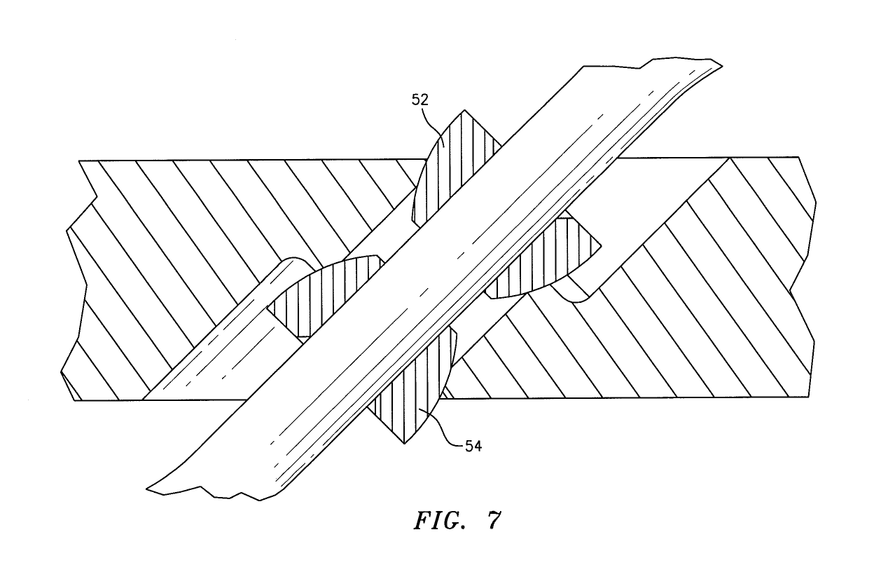

With reference to FIG. 7, another disclosed non-limiting embodiment provides a convex surface 52 on each ferrule 44, 46 with a matched concave surface 54 at each intermediate interface surface 40, 42. The convex surface 52 on each ferrule 44, 46 and the concave surface 54 of the intermediate interface surface 40, 42 increases the contact area and thereby facilitates a seal therebetween.

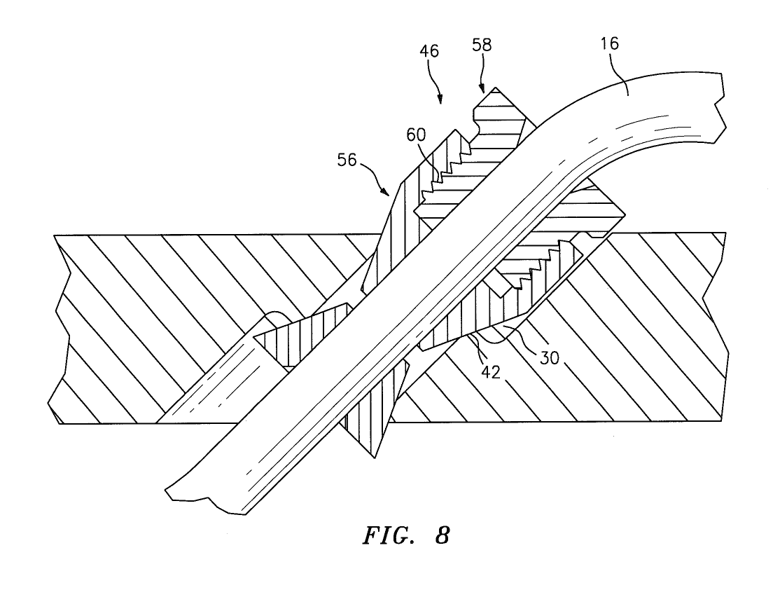

With reference to FIG. 8, another disclosed non-limiting embodiment includes an outer ferrule 46 with a nut 56 and an adapter 58 with a threaded interface 60 therebetween. In this disclosed non-limiting embodiment, the inner ferrule 44 may be as described above.

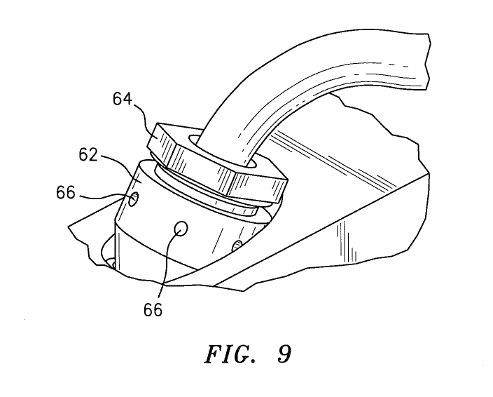

The adapter 58 is brazed to the lead 16 with the nut 56 threaded into the adapter 58. The nut 56 is then threaded out of the adapter 58 to force the nut 56 into the counterbore 30 until seated on the interface 42. The nut 56 and the adapter 58 may include various tool interfaces 62, 64 (illustrated schematically) to facilitate rotation therebetween. For example the tool interfaces 62, 64 may include flats to receive a wrench; holes 66 (FIG. 9) to receive a dowel, knurling to receive a band-wrench or other such tool interface.

The use of two (2) opposed ferrules contains the potting material through the thermal cycles of engine operation. The matched interface provides a mechanical seal in addition to the potting material seal. The hardware disclosed herein is readily usable across engine programs and instrumentation types as well as in production engines for egress seals of various types.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A seal assembly comprising:
a lead;
a first ferrule that surrounds said lead; and
a second ferrule that surrounds said lead.

2. The seal assembly as recited in claim 1, wherein said first ferrule is opposed to said second ferrule.

3. The seal assembly as recited in claim 1, wherein said first ferrule and said second ferrule include opposed convex surfaces.

4. The seal assembly as recited in claim 1, wherein said first ferrule and said second ferrule include opposed ramped surfaces.

5. The seal assembly as recited in claim 1, wherein said first ferrule is brazed to said lead.

6. The seal assembly as recited in claim 1, wherein said second ferrule includes a nut and an adapter with a threaded interface therebetween.

7. The seal assembly as recited in claim 6, wherein said adapter is brazed to said lead.

8. The seal assembly as recited in claim 7, wherein said nut includes a convex surface.

9. The seal assembly as recited in claim 7, wherein said nut is opposed to said first ferrule.

10. An assembly comprising:
a structure that includes an aperture along an axis, said aperture includes an inner counterbore and an outer counterbore separated by an intermediate section;
a lead that extends through said aperture along said axis;
an inner ferrule that surrounds said lead and interfaces with said inner counterbore; and
an outer ferrule that surrounds said lead and interfaces with said outer counterbore.

11. The assembly as recited in claim 10, further comprising a potting material within said intermediate section.

12. The assembly as recited in claim 10, wherein said inner ferrule and said outer ferrule includes a convex surface that abuts an inner intermediate interface surface between said inner counterbore and said intermediate section and an outer intermediate interface surface between said outer counterbore and said intermediate section.

13. The assembly as recited in claim 10, wherein said inner ferrule is brazed to said lead.

14. The assembly as recited in claim 10, wherein said second ferrule includes a nut and an adapter with a threaded interface therebetween.

15. The assembly as recited in claim 14, wherein said adapter is brazed to said lead

16. A gas turbine engine comprising:
a case that includes an aperture along an axis, said aperture includes two (2) opposed counterbore separated by an intermediate section.

17. The gas turbine engine as recited in claim 16, wherein each counterbore defines a first diameter and said intermediate section defines a second diameter, said first diameter greater than said second diameter.

18. The gas turbine engine as recited in claim 16, further comprising an interface that spans each counterbore and said intermediate section.

19. The gas turbine engine as recited in claim 16, wherein said axis is angled with respect to an outer surface of said case.

20. The gas turbine engine as recited in claim 16, further comprising:
a lead that extends through said aperture along said axis;
an inner ferrule that surrounds said lead and interfaces with said inner counterbore; and
an outer ferrule that surrounds said lead and interfaces with said outer counterbore.
